(19) United States
(12) Patent Application Publication
(10) Pub. No.: US 2013/0277160 A1
(43) Pub. Date: Oct. 24, 2013

(54) BRAKE LINING HAVING A BACK PLATE HAVING INCREASED STIFFNESS

(71) Applicants: Jurgen Dreher, Muelheim-kaerlich (DE); Yasar Sarica, Olpe (DE)

(72) Inventors: Jurgen Dreher, Muelheim-kaerlich (DE); Yasar Sarica, Olpe (DE)

(21) Appl. No.: 12/596,236

(22) PCT Filed: Feb. 18, 2008
(86) PCT No.: PCT/EP08/01243

§ 371 Date: Oct. 16, 2009

(30) Foreign Application Priority Data
Apr. 16, 2007 (DE) 10 2007 017 785.4

(51) Int. Cl. F16D 65/092

(52) U.S. Cl. CPC F16D 65/092
USPC 188/250 B

(57) ABSTRACT

A brake pad having increased stiffness comprises a back plate and a friction lining attached to one side of the back plate. Embedded in the lining bed of the back plate facing the friction lining is at least one connecting element having at least one undercut for fastening the friction lining to the back plate, and at least one rib for increasing the stiffness is additionally provided. This arrangement will ensure attachment of the friction lining to the back plate and increased stiffness of the back plate.

The present invention is related to a brake pad and in particular to a back plate for a brake pad.

Brakes are generally for reducing or limiting the velocity of moving machine parts or vehicles. By far the most used brake types, especially in vehicles, are block brakes, drum brakes, and disc brakes. A disc brake has a brake disk running on the hub of the wheel, on which disk brake pads are pressed from one or both sides. Drum brakes are designed as inner shoe brakes, especially in the automotive field. These consist of a brake drum rotating with the rotary axis and of sickle-shaped brake shoes fixed to the knuckle from the inside. During braking procedures, brake shoes and brake pads mounted thereon are moved outwards by way of a spreading mechanism and pressed to the brake drum with force. Disc brakes as well as drum brakes are intended for transforming kinetic energy taken off a rotating axis into heat.

Brakes are essentially made of a caliper, an actuating unit with a pressure plate and a brake pad. The brake pad is usually made of a back plate and a friction pad or friction lining. Due to strong forces acting on the brakes, in particular in large machines such as buses and trucks, backplates are often produced from stamped steel having a grid welded thereon. However, since manufacturing by way of blanking methods is very costly and a back plate is high in weight due to its solid construction, cast back plates are increasingly used. For connecting the friction lining to the cast back plate, the plate is provided with connecting elements such as studs or knobs. For connecting the friction lining in a manner that is stable, sturdy and optimally secured against shearing forces, the connecting elements are provided with undercuts. The connecting elements are embedded into the lining bed of the cast back plates in order to minimize wear or tear of the brake disc or brake drum, respectively, when reaching the wear limit. For this reason, flexural stiffness of cast back plates is generally lower than that of steel back plates. However, due to the forces occurring during braking procedures, in particular with heavy machines such as buses or trucks, this is not advantageous.

The problem of the invention is therefore to provide a back plate which matches a steel back plate with regard to its stiffness.

This problem is solved by a brake pad according to claim 1 of the present invention.

According to one aspect of the present invention, a brake pad with increased stiffness is provided. Said brake pad comprises a back plate having a lining bed and a friction lining mounted on one side of the back plate. Within the lining bed of the back plate facing the friction lining, at least one connecting element having at least one undercut for fastening the friction lining to the back plate is embedded, and additionally, at least one rib for increasing stiffness is arranged. Such an arrangement will ensure connection of the friction lining to the back plate and increased stiffness for the back plate.

Preferably, said at least one rib also has at least one undercut. A ribbing for the purpose of increasing stiffness of the back plate is at the expense of the connection of the lining, since some of the connecting elements will need to be dispensed with. With undercutting the ribbing, the connection of the lining is maintained while obtaining increased stiffness.

Preferably, the back plate is cast from a casting material. In this way, the back plate may be produced in a cost effective way and will have a lower weight than stamped steel back plates. However, the cast back plate will show a stiffness similar to that of a steel back plate due to the ribbing while at the same time ensuring the lining connection by means of undercuts at the ribs.

Preferably, the connecting elements are formed as elevations or projections of essentially knob-like, round, cylindric or angular shape. They may also be formed as essentially rectangular elevations. The friction lining is pressed to the back plate and will clamp with the connecting elements. Due to the undercutting of the connecting elements, adhesive forces between friction lining and back plate will increase.

Preferably, the back plate is formed integrally with the at least one connecting element and the at least one rib from the same material. This will simplify production processes, since back plate, connecting elements and ribs may all be cast in a single process step. Attaching each connecting element and ribs to the lining carrier separately, such as by welding, is not necessary any more.

In another embodiment, the at least one connecting element and/or the at least one rib is riveted, cast, welded or screwed together with said back plate.

In the following, the present invention will be discussed based on exemplary embodiments with reference to the drawings.

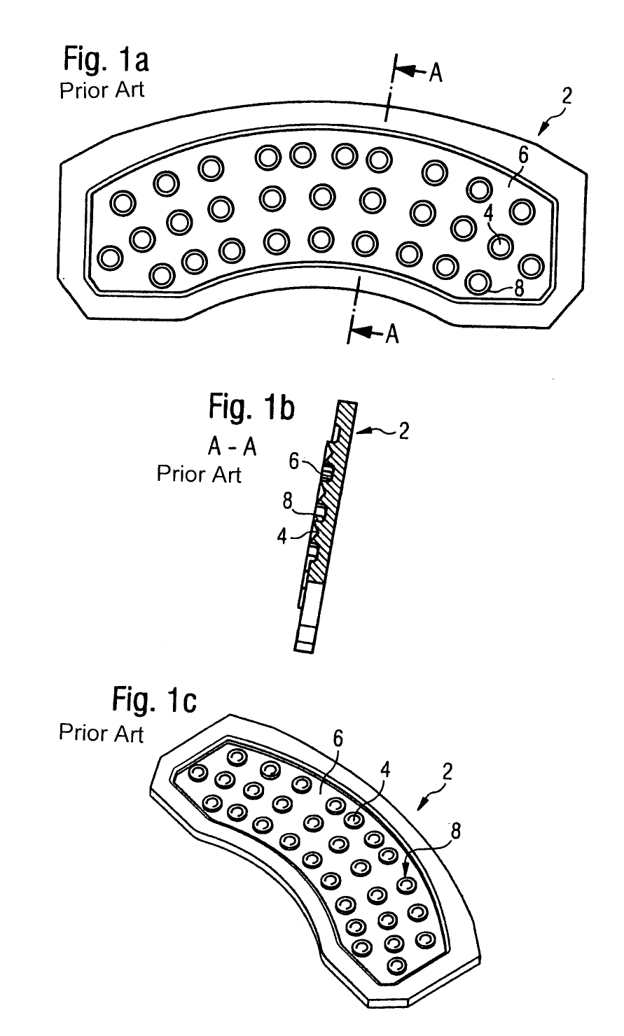

FIG. 1a is a top view of a back plate of a brake pad according to the prior art.

FIG. 1b is a sectional view A-A of the back plate of FIG. 1a.

FIG. 1c is a perspective view of the back plate of FIG. 1a.

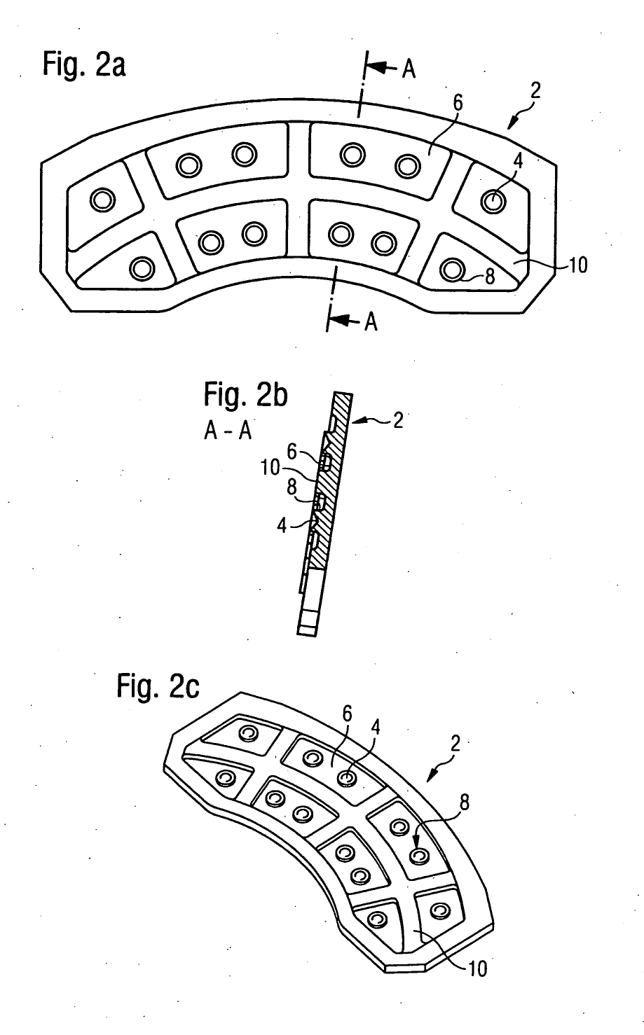

FIG. 2a is a top view of a back plate of a brake pad according to the present invention.

FIG. 2b is a sectional view A-A of the back plate of FIG. 2a.

FIG. 2c is a perspective view of the back plate of FIG. 2a.

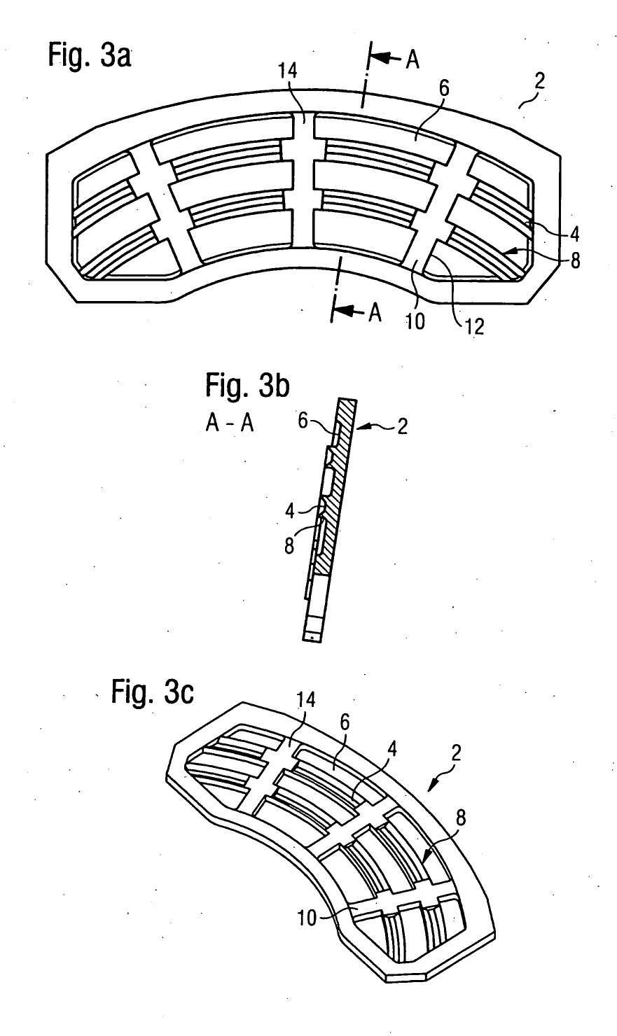

FIG. 3a is a top view of a back plate of a brake pad according to another embodiment of the present invention.

FIG. 3b is a sectional view A-A of the back plate of FIG. 3a.

FIG. 3c is a perspective view of the back plate of FIG. 3a.

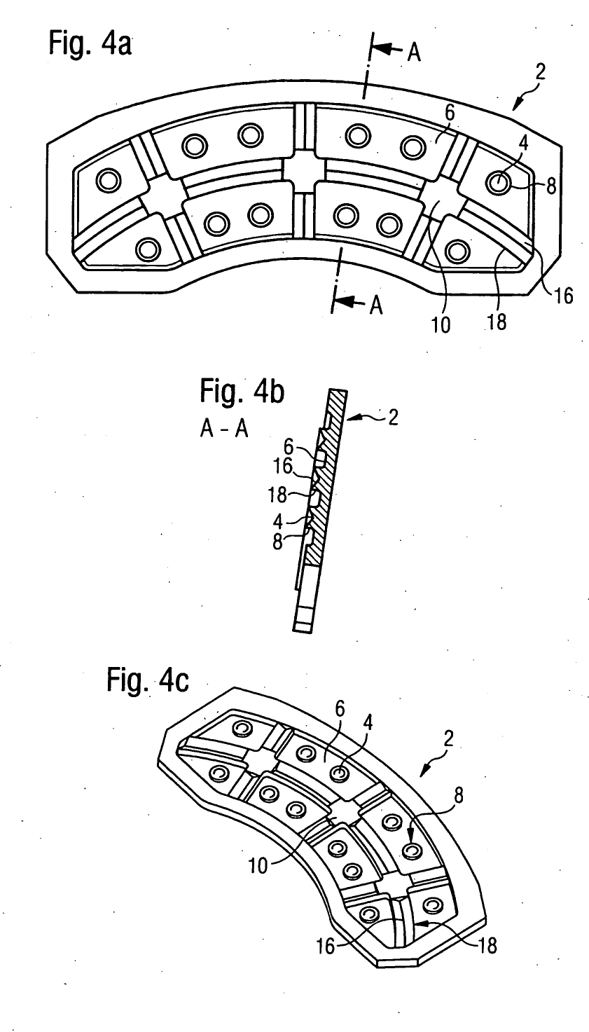

FIG. 4a is a top view of a back plate of a brake pad according to a further embodiment of the present invention.

FIG. 4b is a sectional view A-A of the back plate of FIG. 4a.

FIG. 4c is a perspective view of the back plate of FIG. 4a.

FIG. 1 shows a back plate 2 of a brake pad according to the prior art. FIGS. 1a to 1c are showing back plate 2 as a top view (FIG. 1a), sectional view between A-A (FIG. 1b) and as a perspective view (FIG. 1c), respectively. The back plate 2 comprises a lining bed 6 embedded into the back plate 2, with knob shaped, cylindric connecting elements 4 rising from the lining bed. The connecting elements have undercuts 8 for increasing adhesive forces between friction lining and back plate.

FIG. 2 shows a back plate 2 of a brake pad according to one embodiment of the present invention. Again, FIGS. 2a to 2c show the back plate 2 in a top view (FIG. 2a), a sectional view between A-A (FIG. 2b) and a perspective view (FIG. 2c), respectively. Besides the lining bed 6 embedded into the back plate and the knob shaped cylindric connecting elements 4 projecting from the surface, back plate 2 further comprises ribs 10 for increasing the stiffness of the back plate 2. These ribs may, in accordance with their field of application, be formed at any position within the lining bed 6. One possibility is the formation of longitudinal and transverse ribs as shown in FIG. 2, but e.g. diagonal ribs are equally conceivable. Connecting elements 4 also feature undercuts 8 for better connection of the friction lining to the back plate 2.

FIG. 3 shows a back plate 2 of a brake pad according to an embodiment of the present invention. Again, FIGS. 3a to 3c illustrate the back plate 2 in a top view (FIG. 3a), a sectional view between A-A (FIG. 3b) and a perspective view (FIG. 3c), respectively. The connecting elements rising from the lining bed 6 embedded in the back plate 2 are essentially rectangular in shape and extend lengthwise along the back plate 2. Again, the connecting elements 4 are provided with undercuts 8. Ribs 10 of this embodiment are essentially transverse ribs connected to the connecting elements at crossing points 14. In addition, ribs 10 are undercut as well. In this way, adhesion of the friction lining to the back plate 2 is ensured although some of the connecting elements are omitted.

FIG. 4 shows a back plate 2 of a brake pad according to a further embodiment of the present invention. Once again, FIGS. 4a to 4c illustrate the back plate 2 in a top view (FIG. 4a), a sectional view between A-A (FIG. 4b) and a perspective view (FIG. 4c), respectively. In this embodiment, the connecting elements rising from the lining bed 6 are formed as both knob-like, cylindrical connecting elements 4 and essentially rectangular connecting elements 16. The connecting elements have undercuts 8 or 18, respectively. Essentially rectangular connecting elements 16 are linked to each other by means of cross-shaped ribs 10. This ribbing will lead to increased stiffness of the back plate while ensuring connection of the lining by means of undercuts at the ribs.

The back plates as shown in the figures may preferably cast from a casting material or from any other suitable material. To this end, the complete back plate including all connecting elements and ribs may be cast integrally from a single material. However, it is also possible to rivet, cast, weld or screw the connecting elements and/or the ribs together with the back plate.

1. A brake pad having increased stiffness, comprising
a back plate having an embedded lining bed, and
a friction lining mounted on one side of the back plate;
wherein at least one connecting element having at least one undercut and additionally at least one rib for increasing stiffness is formed in said lining bed of said back plate facing said friction lining.

2. The brake pad of claim 1, wherein said at least one rib has at least one undercut.

3. The brake pad of claim 1, wherein said back plate is cast from a casting material.

4. The brake pad of claim 1, wherein said at least one connecting element is formed as an elevation of knob-like, round, cylindric or angular shape.

5. The brake pad of claim 1, wherein said at least one connecting element (4) is formed as a rectangular elevation.

6. The brake pad of claim 1, wherein said back plate is formed integrally from the same material with said at least one connecting element and said at least one rib.

7. The brake pad of claim 1, wherein said least one connecting element is riveted, cast, welded or screwed together with said back plate.

8. The brake pad of claim 1, wherein said wherein at least one rib is riveted, cast, welded or screwed together with said back plate.
